(19) United States
(12) Patent Application Publication
(10) Pub. No.: US 2007/0100841 A1
(43) Pub. Date: May 3, 2007

(54) SYSTEM AND METHOD FOR DISCOVERY OF BUSINESS PROCESSES

(75) Inventors: Alex Elkin, Littleton, MA (US); Scott Opitz, Media, PA (US)

Correspondence Address: BLANK ROME LLP, ONE LOGAN SQUARE, PHILADELPHIA, PA, 19103, US

(73) Assignee: LOGIC EXPLORERS INC., Media, PA (US)

(21) Appl. No.: 11/163,867

(22) Filed: Nov. 2, 2005

(51) Int. Cl. G06F 7/00

(52) U.S. Cl. 707/100

(57) ABSTRACT

A method and system are described for discovering business process definitions for a particular enterprise. A concept of Archetype is introduced where an archetype represents the industry-specific but enterprise-neutral set of process definition and recognition rules. The actual business processes of an enterprise are obtained by matching the archetypes to the artifacts collected from the enterprise.

Many applications require knowledge of business processes. A detailed knowledge of business processes is necessary for a variety of purposes, for example: process monitoring, improvements, reengineering, and simulation among many others.

Any enterprise has a number of business processes under execution at any point in time, whether these processes are defined explicitly through some specialized business process management software technologies or the processes exist as a combination of procedures, practices, human decisions, other manual operations or those which occur within computer systems, etc.

Explicit definition of business processes typically requires the use of special graphical or textual notations, such as BPEL, UML, or proprietary definition languages. The process of building these definitions includes obtaining the information from the enterprise personnel, formalizing it according to the paradigm required by the chosen notation and finally creating one or more schemas using these special process modeling tools.

This approach has several fundamental problems. First, it requires involvement of a large number of people, each being an expert in a particular aspect of the enterprise's business. Second, these people require specialized training in order to describe the business processes in terms of the chosen notation. Third, the process definitions obtained from these personnel may not accurately reflect the actual processes of the enterprise but rather an assumption of what the processes are generally thought to be. Finally, the resulting process definitions become obsolete as soon as the enterprise changes.

In order to avoid the high costs and the drawbacks of explicit process definition, a “process mining” approach was introduced. This approach makes an attempt to obtain the process definitions by collecting and analyzing various artifacts produced by the execution of the process instances. The artifacts may include the log files, audit records, process events, database records, documents, etc.

A variety of mathematical techniques was employed to obtain the process schemas from these collections of artifacts, including Petri Nets, Markov Chains, Neural Networks. In general, the procedure includes the following steps:
(1) Identifying the artifacts which belong to the same process instance
(2) Constructing the linear sequence of process steps based on the artifacts belonging to the same process instance
(3) Merging a number of linear sequences belonging to the same process instance into the process schema of a particular business process

While this approach is widely used in academic research, its practical implementation is very limited. Most researchers simply assume the artifacts contain a special attribute (property) representing a unique identifier of the process instance. The relation of real-life artifacts to the process instances is typically hidden and is very dependent on the specific implementation of any enterprise.

Merging these linear sequences into process schemas also presents a number of unresolved problems. For example, a real process schema may have two different branches depending on a logical condition. While the discovered schema can identify the point where the process path branches, the logical condition remains unknown.

The implementations set forth in the following description do not represent all implementations consistent with the claimed invention. Other implementations can be used and structural and procedural changes may be made without departing from the scope of the present invention.

Archetype

Nodes and Events

An Archetype is the collection of domain specific knowledge components which together constitute the description of the specific type of an enterprise. An archetype does not define any particular enterprise but rather a superset of all enterprises of the given kind. In one embodiment of the invention, the archetype may describe the enterprise performing the operations of a retail business; while another archetype may be related to an insurance business. Consistent with the embodiments of the invention, the archetype could be called “subject domain knowledge”, “knowledge base”, etc.

Thus an archetype typically describes some abstract enterprise that includes the features a real enterprise may or may not have.

An archetype describes the business processes of the abstract enterprise in terms of Nodes and Events. Nodes are the parts of the enterprise which participate in the business processes. In one embodiment of the invention the nodes could be defined as Warehouse, Store, Financial Department, Delivery Truck, etc.

An event represents the abstraction of an artifact that could be collected from a Node. In one embodiment of the invention, the events related to the Warehouse node are: “Truck has arrived”, “Palettes are unloaded”, “Items are placed on shelves”, etc. An event has a special identifier common for all events of this kind. Such an identifier is commonly known as “Event Name” or “Event Type”.

An event may have a number of other named or otherwise identifiable properties including data fields. In the example above, the “Truck has arrived” event may have the data fields “Arrival Time”, “Truck plate number”, “Truck RFID tag”, “Shipment Number”, etc. Consistent with the embodiments of the invention, the declared data fields of an event include a superset of the data expected to be obtained from a node of this kind.

Archetype Processes

An archetype includes one or more process descriptions. A process is defined as a structured set of nodes and events and other components related to determining the next step in the process execution. In one embodiment of the invention, the control components may include components providing repetitive fragments of the process schema (Loop), components providing the direction based on the logical expressions (Switch), and components declaring the concurrent execution of several branches (Fork), etc.

A process description may have a number of named or otherwise identifiable properties. Consistent with the embodiments of the invention, some properties of the process may be mapped into the properties of the events included in the process.

An archetype may include any number of data mapping rules. A data mapping rule establishes the correspondence between two or more properties, such as a property of an event and a property of another event or a property of a process or a property of a node.

Views and Layouts

An Archetype may include a number of views and layouts visualizing the archetype processes. The views and layouts utilize the properties of the process, nodes and events to visualize them in the form, consistent with the kind of the abstract enterprise described by the archetype.

Derived Parameters and Indicators

An archetype may include a number of parameters, derived from the properties of the processes, nodes and events. In one embodiment of the invention, these parameters are what is commonly referred to as Key Performance Indicators—values representing the key metrics for a particular kind of business.

Consistent with the embodiments of the invention, the derived parameters and indicators may have none or many display forms defined in the archetype.

In one embodiment of the invention, the archetypes are stored on a computer readable medium in a variety of formats, such as database records and/or XML files.

Recognition Rules

The set of recognition rules is part of the archetype. Any event and any property of an event, node and a process may have a collection of rules defining how an event or property can be recognized among the total set of real enterprise artifacts. In one embodiment of the invention, the recognition rules are based on:
(1) Semantic structure of the names or otherwise unique identifiers of the events and properties
(2) Hierarchical structure of the events and properties where the structure may include data types
(3) Data relationships between the properties described in the Data Mapping Rules
(4) Values and value ranges of the properties of the events, nodes and processes
(5) Timing sequences in which the events related to the same process appear in the artifact collections
   Another embodiment uses additional recognition techniques, such as neural networks, pattern analysis, etc.

A recognition rule includes the properties of “certainty” or “weight” as an indicator of how likely the activation of the rule means an event or a property is recognized correctly. In one embodiment of the invention, the values for the rule's weight are set dynamically based on past matches.

Discovery Process

The process of discovery generally consists of the steps described herein. The order of the steps can vary depending on the embodiment.
(1) The embodiment of the invention collects the available artifacts from various parts of the enterprise;
(2) A person or persons select one or more archetypes consistent with the enterprise whose processes are to be discovered;
(3) A person, at his or her discretion, may change the archetype, or set the values of some properties of the processes, nodes and events;
(4) The invention executes the recognition rules for each selected archetype against the collected artifacts;
(5) The invention determines the best match for every element of the archetype such as node, event and their properties and the best archetype to match the artifacts;
(6) The invention removes the elements of the archetype, such as node, event and their properties which do not have matches in the real enterprise;
(7) The invention visualizes the resulting archetype and the collected artifacts using the display forms included in the archetype as well as user definable displays;
(8) A person or persons review the results of the recognition. If false matches are found, the user makes manual corrections by removing the incorrect associations or by establishing the correct associations and continuing with the recognition step (4);

What is claimed is:

1. A method of discovering business processes for a particular enterprise, the method comprising:
Defining enterprise-neutral, industry-specific archetypes;
Defining recognition rules used to match the elements of the archetypes and their properties among the artifacts collected for the particular enterprise;
Matching the archetype and its elements and their properties against the collected artifacts;
Obtaining a process schema for a given enterprise as a subset of the archetype and a mapping between the archetype elements and the enterprise artifacts;
Obtaining the values of the indicators for the given enterprise through the mapping between the archetype elements and the enterprise artifacts.

2. The method of claim 1, wherein defining the enterprise-neutral, industry-specific archetypes comprises defining a superset of the properties and processes that any specific enterprise in this industry may have.

3. The method of claim 2, wherein defining the enterprise-neutral, industry-specific archetypes comprises defining one or more processes as a set of nodes and events. Processes, nodes and events have named or otherwise identifiable properties.

4. The method of claim 1, wherein defining the recognition rules to match the elements of the archetypes and their properties among the artifacts, collected for a particular enterprise, comprises defining a set of rules for one or more of the nodes, events, and properties of the processes, nodes and events. Each of the rules provides the probability of a match between an element of an archetype and the collected artifacts based on semantics, structural similarities, data values, timing and sequencing.

5. The method of claim 1, wherein matching the archetype and its elements and their properties against the collected artifacts comprises execution of the recognition rules, determining the best matches, presenting the results to a person or persons, accepting a person's input and corrections, and repeating this step until the person is satisfied.

6. The method of claim 5, wherein presenting the results of the match to a person or persons comprises displaying one or more of the views with the results of the match and none or more of the views in which the collected artifacts are applied to the archetype processes to give the user a better understanding of the results of the recognition.

7. The method of claim 1, wherein obtaining the process schema for a given enterprise as a subset of the archetype and a mapping between the archetype elements and the enterprise artifacts comprises updating the archetype based on the results of the recognition of the archetype elements, including but not limited to removing the archetype elements not found in the artifacts, obtaining the actual values for the properties, obtaining the actual relationships between and the hierarchies of the archetype elements, determining the timing and logical dependencies between the steps in the business processes.

8. The method of claim 1, wherein obtaining the values of the indicators for a given enterprise through the mapping between the archetype elements and the enterprise artifacts comprises translating the definitions of the indicators from the properties of the archetype elements to the properties of the enterprise artifacts thus allowing for calculating these indicators in real time as the artifacts are collected.
